(19) United States
(12) Patent Application Publication
(10) Pub. No.: US 2015/0242795 A1
(43) Pub. Date: Aug. 27, 2015

(54) STRENGTHS RECOGITION SYSTEM

(71) Applicant: O.C. Tanner Company, Salt Lake City, UT (US)

(72) Inventors: David Hilton, North Salt Lake, UT (US); Zlatina Todorova, Salt Lake City, UT (US); Jason Andersen, Sandy, UT (US); Bobbi Alexandrova, Salt Lake City, UT (US)

(21) Appl. No.: 14/631,172

(22) Filed: Feb. 25, 2015

Related U.S. Application Data
(60) Provisional application No. 61/944,814, filed on Feb. 26, 2014.

(51) Int. Cl. G06Q 10/06

(52) U.S. Cl. CPC G06Q 10/06398

(57) ABSTRACT

A system extracts strengths attributable to persons from a database containing recognition transactions within a company communication system and provides metrics that reflect skills attributable to the persons for performance reviews, evaluations and talent management. A skills finder feature searches words from a predefined dictionary comprising words associated with strengths. A controller initiates the skills finder feature to identify transactions created or modified within the company communication system within a current predetermined period of time. A skills finding search engine searches a temporary table for words within the dictionary and extracts each strength recognized. Each extracted strength is associated with one or more skills categories. Recognitions are aggregated by skills categories and compiled into an aggregated table containing information depicting the skills categories for each of the persons accumulated from previous and current predetermined periods of time. At least a portion of the information in the aggregated table is displayed.

### RELATED APPLICATION

This application claims the benefit of U.S. Provisional Application Ser. No. 61/944,814, titled Personal Strengths Recognition System, filed on Feb. 26, 2014.

This application has related subject matter to U.S. Patent Application No. [presently unknown], filed on the same day as this application and is titled Recognition Email Listener. The aforementioned patent application and provisional patent, in their entirety, are expressly incorporated into this application by this reference.

### BACKGROUND OF THE INVENTION

### Field of the Invention

The present invention relates to systems and methods for extracting and converting information extracted into metrics. More specifically, the present invention relates to systems and methods that have performance-based recognition features to mine an individual's eCards, award nominations, and other corporate sponsored recognition activities to highlight skills and attributes that peers and co-workers notice so that such highlighted skills are not lost or forgotten, but are displayed on dashboards for each individual as well as the dashboards for members of the company leadership. The distilled skills information provides objective metrics that may be used for performance reviews, evaluations, and talent management that heretofore were typically solely subjective in nature.

### BRIEF SUMMARY OF THE INVENTION

The present invention has been developed in response to the present state of the art, and in particular, in response to the problems and needs for identifying and quantifying skills exhibited by employees for recognition and evaluation purposes.

The strengths recognition system of the present invention uses a skills finder feature with a skills finding search engine, using database functionality and data replication technology, to extract recognition strengths from a company's communication system that may include award nominations, eCards, and other recognition-related email transactions. The strengths recognition system mines a company's communication system for predefined terms or phrases that are indicative of certain skills and aggregates the information by individual employee and presents the information on a web site, on a dashboard, or in an email. Gathered data represents the individual employees' strengths as recognized by others and the number of times each employee has been recognized for those strengths.

At periodic intervals (e.g., every two minutes or any other suitable interval), a controller initiates a process that accesses new transactions to process through the skills finder feature and its skills finding search engine to extract strengths-related information. A temporary table of the mined information from the new transactions is created and indexed. The system executes against the temporary table, aggregates the results by individual employee, and populates a final aggregated table. The gathered data, as aggregated and indexed, represents each employee's strengths and the number of times each employee has been recognized for those strengths.

Highlighted skills can be displayed on dashboards for each individual employee as well as dashboards for their leader or other members of the company leadership. Such displays are visual evidence of the recognition each individual employee has received, bolstering self-esteem, self-confidence, and employment loyalty. Additionally, such displays provide company leadership with an additional metric, not typically available otherwise, for evaluating employee performance for recognition and advancement.

The system uses a dictionary that comprises a predefined list of all strengths extractable by the skills finding search engine. The predefined dictionary is expandable to customize terminology for skills extraction. The dictionary comprises words specifying strengths and the strengths falling within each main category of skills. These identified skills are placed in a table, aggregated, and indexed. The table or another table is configured to provide the results of the extraction and the aggregation of the information into skills categories by team and/or individual, providing company management with a metric related to recognition and skills exhibited by an individual employee or a team of employees.

These and other features of the present invention will become more fully apparent from the following description, or may be learned by the practice of the invention as set forth hereinafter.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended figures. Understanding that these figures depict only exemplary embodiments of the invention and are not therefore to be considered to be limiting of its scope, the invention will be described and explained with additional specificity and detail through the use of the accompanying figures in which:

FIG. 1 is a schematic depiction of the high level architecture of an exemplary strengths recognition system of the present invention;

FIG. 2 is a schematic depiction of the high level architecture of an exemplary skills finder feature;

FIG. 3 is a depiction of an exemplary screen shot of a Wall of Fame™ webpage for highlighting an email nomination for employee recognition;

FIG. 4 is a depiction of an exemplary table containing information extracted regarding various defined skills exhibited by various individual employees;

FIG. 5 is a depiction of an exemplary account page for an individual employee showing his recognized skills and the monetization of skills recognized into a rewards account that the individual employee can self-manage and redeem; and

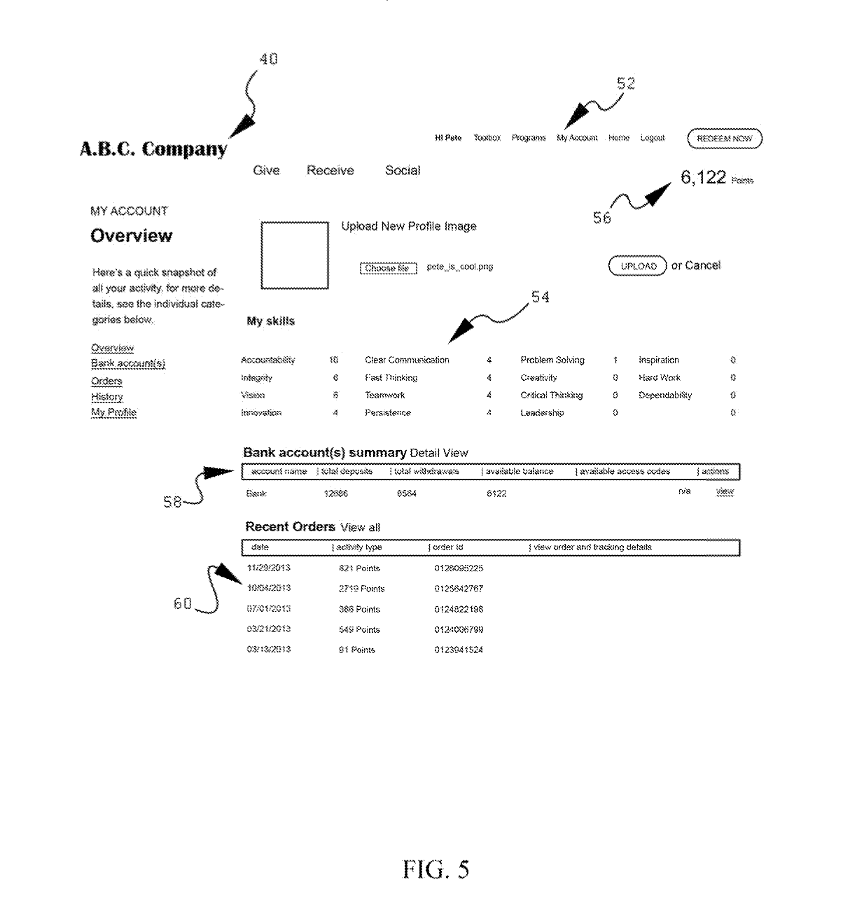

FIG. 6 is a depiction of an exemplary table provided to company leadership that summarizes team skills recognized and skills recognized for individual employees.

REFERENCE NUMERALS

| | |
|---|---|
| strength recognition system 10 | skills finder feature 12 |
| skills finding search engine 14 | controller 16 |
| change data capture feature 18 (CDC) | results storage 20 |
| service provider 22 (API) | requester 24 |
| temporary table 26 | aggregated final table 28 |
| recipient identifier 30 | nominator identifier 32 |
| textual content 34 | comment area 36 |
| commenter 38 | company identifier 40 |
| company statement 42 | list of employees 44 |
| heading 46 | skill category(ies) 48 |
| all skills category 50 | account page 52 |
| My skills section 54 | point balance 56 |
| account summary 58 | redemption history 60 |
| team summary table 62 | team skills section 64 |
| employee skill section(s) 66 | |

### DETAILED DESCRIPTION OF THE INVENTION

The presently preferred embodiments of the present invention will be best understood by reference to the appended figures. It will be readily understood that the components of the present invention, as generally described and illustrated in the figures herein, could be arranged and designed in a wide variety of different configurations. Thus, the following more detailed description of the exemplary embodiments of the present invention, as represented in the figures, is not intended to limit the scope of the invention, as claimed, but is merely representative of exemplary embodiments of the invention.

The word “exemplary” is used exclusively herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

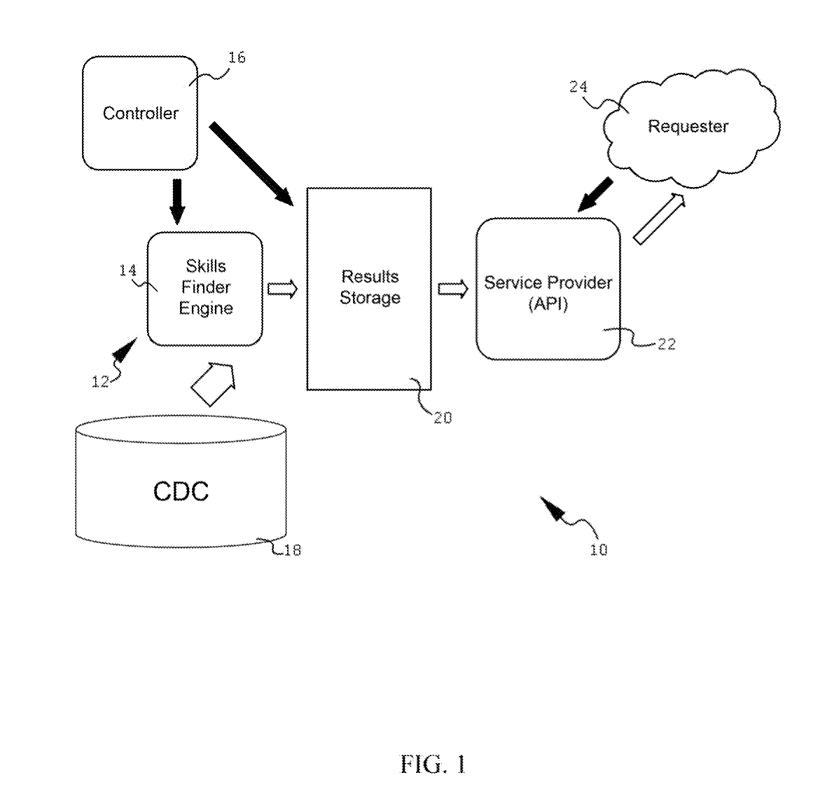

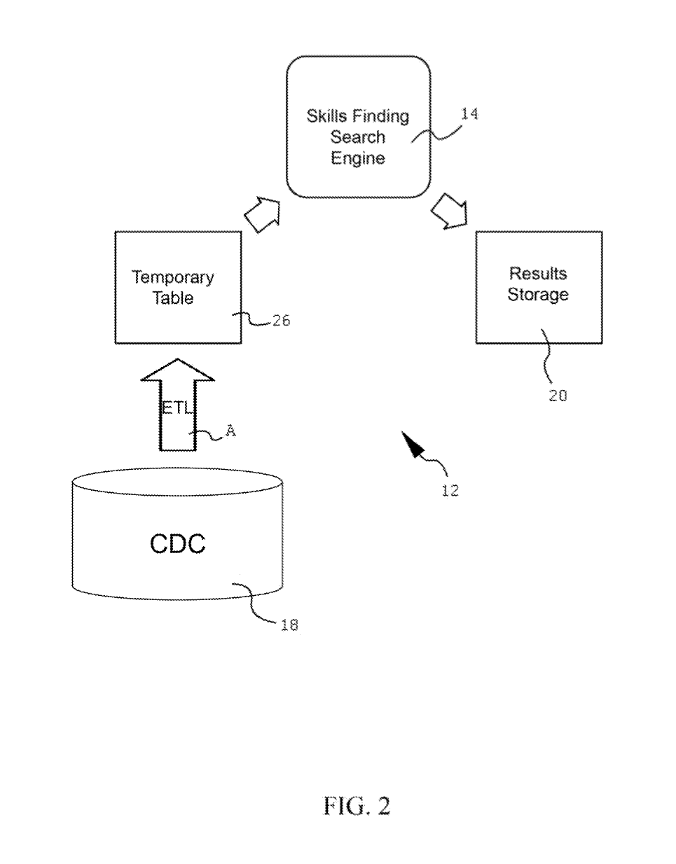

An exemplary strengths recognition system 10 (sometimes referred to as “system 10”) of the present invention is depicted in FIG. 1. System 10 comprises a skills finder feature 12 (see FIG. 2) with a skills finding search engine 14, a controller 16, database functionality and data replication technology with a change data capture feature 18, a results storage 20, and a service provider 22 such as an application programming interface (API). Requesters 24, such as dashboards or persons making direct informational requests receive the requested data from system 10.

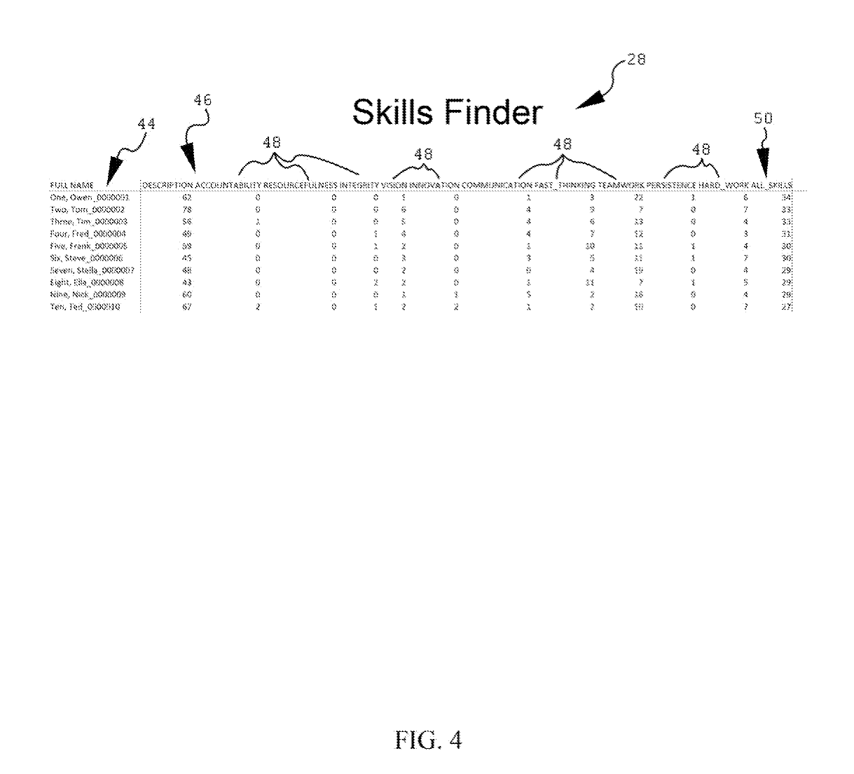

The skills finder feature 12 is shown in FIG. 2 and comprises the skills finding search engine 14 to extract recognition strengths, the change data capture (CDC) feature 18 to extract, transform, and load data into a temporary table 26 against which the skills finding search engine 14 executes to create an indexed and aggregated final table 28 (see FIG. 4) and is placed in the results storage 20.

Referring to FIGS. 1 and 2, the controller 16 initiates a process to perform an extraction of recognition strengths at predetermined intervals. Database functionality and data replication technology extract and aggregate the communication transactions since the most recent extraction, and the CDC feature 18 creates a temporary table 26 of the data extracted. The skills finder search engine 14 of system 10, using a predefined dictionary, extracts recognition strengths from the most recent award nominations, eCards, and recognition-related email transactions contained in a company's communication system that have been placed in the temporary table 26. This extracted data is placed in the results storage 20 in the aggregated final table 28 containing information extracted regarding various defined skills exhibited by various individual employees. The information populating the aggregated final table 28 is organized by individual employee and may be presented on a web site, on a dashboard, or in an email. The gathered data, as indexed and aggregated, represents a metric of individual employee's strengths and the number of times each employee has been recognized for such strengths.

In an exemplary strengths recognition system 10, the controller 16 initiates a process to perform an extraction of recognition strengths at predetermined intervals. The predetermined intervals may be regular (e.g., every two minutes or whatever amount of time period would be appropriate for the user company) or otherwise periodic (e.g., based on volume of communications such as every 500 communications).

The process initiated by controller 16 looks for new transactions to process through the skills finder feature 12 and its skills finding search engine 14. New transactions are provided to process by real time replication software technology such as Shareplex by Quest or any other suitable real time replication software technology. The real time replication software technology replicates the recognition data in real time and the CDC feature 18 of the software keeps track of every change that happened in the data source during the predetermined interval. A temporary table 26 is created and indexed of data mined from the new transactions that occurred after the previous extraction.

Any of the strengths, contained within the new transactions being processed, that are listed in a predefined list of strengths within a dictionary are extracted for further processing. For example, the predefined dictionary of terms and phrases might include terms such as “help,” “quick response,” “timely,” “out-of-the-box,” “analysis,” and “team player” that are indicative of desired skills. If those terms or phrases are contained in any of the new transactions, those transactions are extracted and are loaded into the temporary table 26. This extract, transform, and load function is performed by the CDC feature 18 and designated at arrow A of FIG. 2. The skills finding search engine 14 executes against the temporary table 26.

The new transactions that contain references to strengths associated with skills to be highlighted may be displayed on dashboards for each individual employee to memorialize the recognition. Additionally, those same transactions or certain of those transactions may also be displayed on dashboards of various members of the company's leadership, particularly the transactions relating to subordinate employees of a company leader.

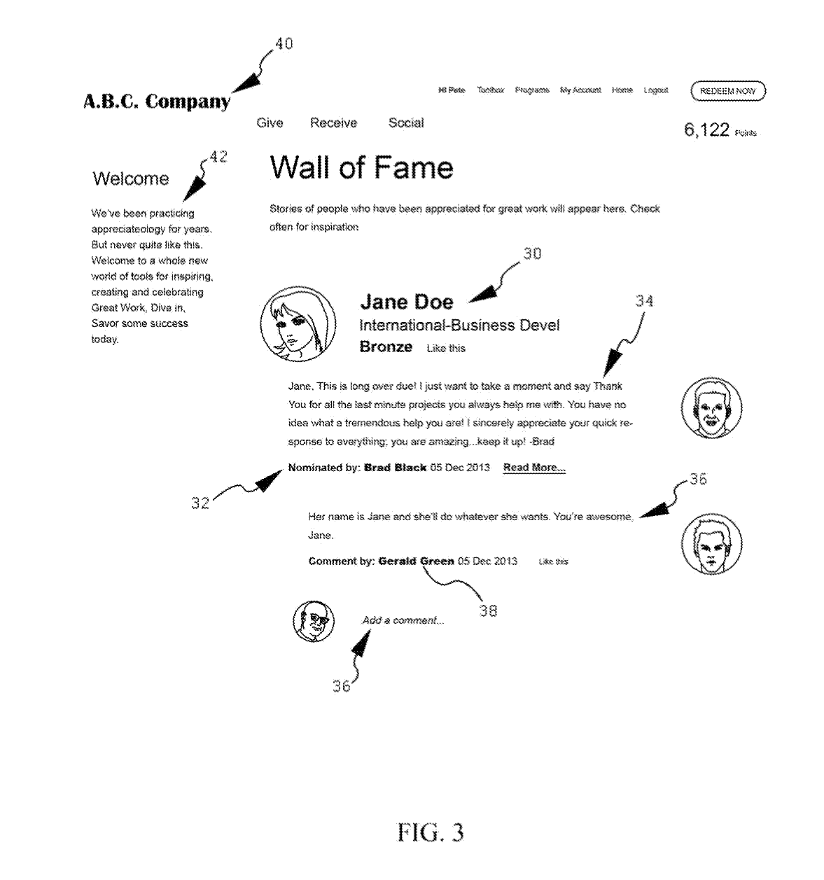

As shown in FIG. 3, the company may have a company-wide recognition page such as a Wall of Fame™ entry for displaying transactions that have been extracted for display to inform others of the recognition and to allow them to comment. An exemplary Wall of Fame™ may comprise a recognition recipient identifier 30, a nominator identifier 32, textual content 34 of the nomination, a comment area 36 for receiving comments from a commenter 38, as well as company information such as a company identifier 40 and a company statement 42. The use of the Wall of Fame™ is intended to encourage open recognition and commentary regarding such recognition within a company.

The extracted strengths are associated with one or more skills categories indicative of the strength exhibited. The terms and phrases mentioned above might be associated with skills categories as follows: “help” and “team player” may be associated with a “teamwork” skills category, “quick response” may be associated with a “fast thinking” skills category, “timely” may be associated with an “accountability” skills category as well as a “hard work” skills category, “out-of-the-box” may be associated with a “vision” skills category as well as an “innovation” skills category, and “analysis” may be associated with a “critical thinking” skills category. The skills finder feature 12 then aggregates the results by individual employee and populates a final aggregated table.

FIG. 4 depicts an aggregated final table 28 containing information extracted regarding various defined skills exhibited by various individual employees. The final aggregated table 28 contains metrics data relating to the skills a company may desire to track. The final aggregated table 28 comprises a list of employees 44 indicated by name and employee number, a heading 46 that lists skill categories 48 individually and an all skills category 50 that is an aggregate of all skill categories 48. With respect to each employee listed, the number of recognitions that employee has received is indicated for each skill category 48 and the all skills category 50; for example, Owen One has received 22 separate recognitions for the “teamwork” skill and 34 separate recognitions for all skills combined.

An exemplary system 10 may monetize the strengths and/or skills extracted by assigning values to such strengths and/or skills. These values (e.g., points) can be added to an award account for each individual employee. As shown in FIG. 4, an exemplary account page 52 may be provided for an individual employee. The account page 52 may be configured to include employee-specific information such as the skills recognized for the employee in a “My skills” section 54, the present point balance 56, an account summary 58 showing the accumulated points received for skills recognition or any other avenue of recognition, and a redemption history 60 that reflects when and how the employee redeemed points for awards from the company's award store or some other awards system.

Point values may be given in addition to the strengths and/or skills recognized or can be assigned by a member of the company leadership to fit the situation. The points awarded can be automatically added to the employee's award account or can be added at the discretion of a member of the company leadership.

Every data request, including requests from dashboards for individual employees and members of company leadership and direct informational requests, goes against a middle-tier application programming interface (API) 22, which requests data from a database function that guards the access to the aggregated table. The database function retrieves data from the aggregated final table 28 and returns it back to the middle-tier API 22 that then sends it to the requester 24. Although a person of ordinary skill in the database art will understand that any of a number of databases can be used suitably, an Oracle database has the functionality herein described.

The dictionary comprises a predefined list of strengths to be extracted by the skills finding search engine 14. The dictionary list comprises words specifying strengths and those strengths are associated with one or more main categories of skills. The dictionary is expandable to include additional strengths and/or skill categories. Engine setup is performed once as part of the initial configuration and is required with every future dictionary change. After predefining the dictionary, all words are processed through an engine to find their roots. Ruby stemmer gem may be is used to generate the roots for each word in the dictionary. The roots are used in the searching and extracting.

By way of example, the skills categories 48 may include skills such as accountability, innovation, vision, integrity, clear communication, fast thinking, teamwork, persistence, problem solving, creativity, critical thinking, leadership, inspiration, hard work, and dependability. Associated with each of these skill categories 48 are words and word roots for various strengths, and each term of strength is associated with one or more of the skills categories 48. For example, the strength of exhibiting responsibility (with the root of “responsible”) and the strength of being on budget (with a root of “on budget”) may be associated with the root “accountable” and the skills category 48 of “accountability.”

The skills finding search engine 14 performs the strengths extraction process. It is responsible for mining the strengths from a temporary database table 26, indexing, using pre-built dictionary and database functions to complete the extraction.

An exemplary architecture for the skills finder feature 12 is shown in FIG. 2. The skills finding search engine 14 uses a minimized working data set to defend against future growth problems. It uses the temporary table 26 to hold only the working set. To optimize performance, the temporary table 26 may be located in the same database and close to the analyzed dataset. Database indexes may be created to improve the engine performance. The temporary table 26 may be archived after every run to facilitate future troubleshooting. Once archived, the temporary table 26 may be dropped so that a new temporary table 26 may be created during the next run. This skills finding search engine 14 uses database text searching capabilities to do the strengths extraction and also uses database thesaurus functionality to incorporate the predefined dictionary and to search for dictionary matches and matches to synonyms. As described, the number of passes over the working set is minimized.

The skills finder feature 12 uses the aggregation table 28 to store the final results of the skills finding search engine 14 strength extraction. The results are stored by individual employee and per skills category. This structure enhances performance optimization and decouples the front end data requests from the back-end data mining. Every two minutes (or any other predetermined period) after the skills are extracted, the results are added to the already aggregated data in that table. In this manner the existing results storage 20 always keeps a running total of the recognized skills per individual employee. The running total can be kept for a set period of time such as twelve (12) months, a calendar year, a fiscal year, a rolling twelve-month period, or whatever period is desired by the company. The below example shows that process in detail.

Example table structure and process may include these items of data and structure:
A column to reference to John Smith
Year (2014)
Month (January)
Accountable_Count (5) indicating John has been recognized 5 times for a particular strength. Every two minutes the new numbers are added to the existing count. If John is recognized one more time for the same skill in the next two minutes, the number in this column is updated to (6). This is done to follow all main strength categories as per the dictionary in a category format similar to the Accountable category format.
Last Modified on Jan. 10 2014
STP (Sold to Party or Client Number) referencing to the company
The table structure is desirable for performance optimization and for allowing for slicing and dicing the extracted strengths results by different criteria.
The access to the database table structure is guarded by a database function that handles requests for data from the table.

The middle-tier API 22 handles all requests to the database. Every time the front end (a requester 24) requests data from the aggregated final table 28 it goes through the API 22 and calls the database function that extracts the needed data from the table 28 and provides it back to the requester 24.

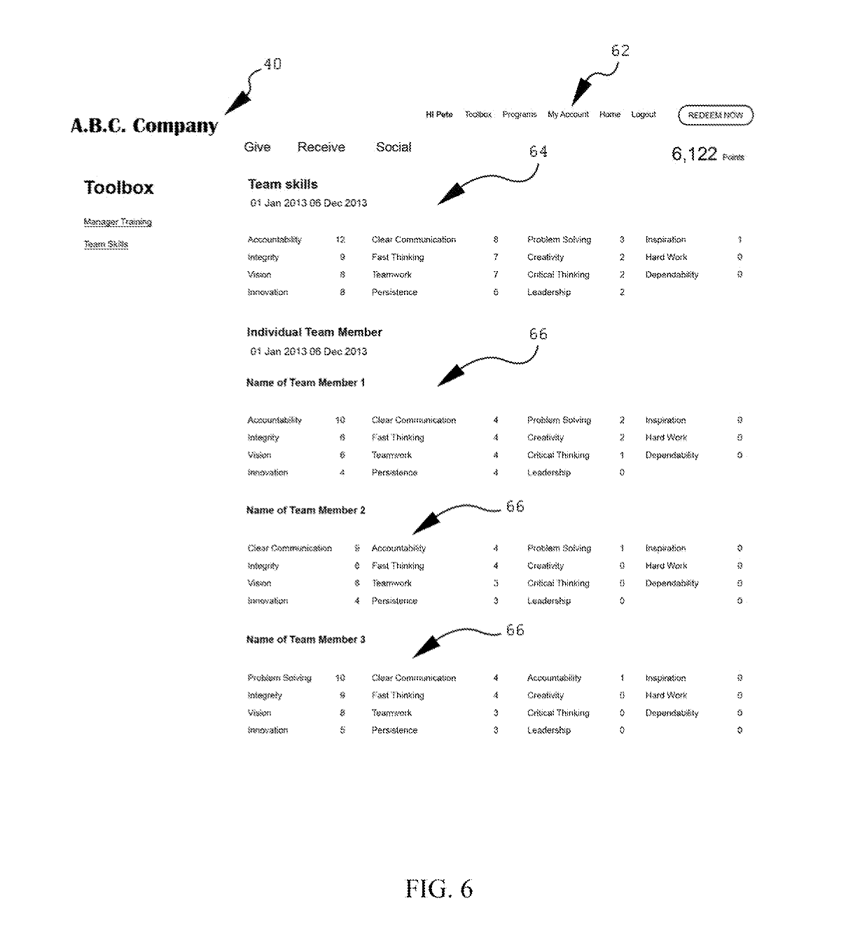

The skills finder feature 12 functionality finds meaning in the eCards, eButtons, and Nomination comments and presents the recognized strengths information to the end user (the company leadership) to be used for performance reviews, evaluations and talent management. FIG. 6 is an exemplary team summary table 62 that may be provided to a member of the company leadership that summarizes team skills recognized and skills recognized for individual employees. The team summary table 62 may comprise a team skills section 64 that aggregates the recognitions received by members of a team to reflect overall team strengths and skills, and individual employee skills sections 66 that indicate the skills recognitions received by individual team members. This team summary table 62 provides company leadership with metrics, otherwise unavailable, that may be valuable for performance reviews, evaluations and talent management.

Additionally, the system has expandable capabilities so that the system may scale to mine increased data volume and serve customer needs across industries and geographical boundaries.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. A system for extracting strengths attributable to one or more persons from a database containing communication transactions within a company communication system and providing metrics that reflect skills attributable to the persons comprising:
a skills finder feature having a skills finding search engine and a dictionary comprising words associated with strengths;
a controller for initiating the skills finder feature to identify communication transactions created or modified within the company communication system within a current predetermined period of time, the skills finder feature executes against a temporary table of the communications transactions for the current predetermined period of time;
the skills finding search engine searches the temporary table for words within the dictionary and extracts each strength recognized in a communication transaction for each of the persons, the skills finder feature associates each of the extracted strengths with one or more skills categories, aggregates the skills categories, and compiles an aggregated table that contains information depicting the skills categories for each of the persons accumulated from previous predetermined time periods and the current predetermined period of time; and
a display of at least a portion of the information depicted in the aggregated table.

2. A system as in claim 1 wherein the communication system is an email system.

3. A system as in claim 1 further comprising a middle-tier application programming interface that processes any request for the information from the aggregated table.

4. A system as in claim 1 wherein the dictionary further comprises root words associated with strengths and with associated skills.

5. A system as in claim 1 wherein at least one of the strengths recognized has a value that one of the persons can redeem for an award.

6. A system as in claim 1 further comprising a change data capture feature that determines the communication transactions that occurred since the controller last initiated the skills finder feature to conduct an extraction of strengths.

7. A system as in claim 6 wherein the change data capture feature creates the temporary table.

8. A system as in claim 6 wherein the change data capture feature performs an extract, transform, and load function.

9. A system as in claim 1 wherein the display is a company-wide webpage to which recognition given in a communication transaction to an individual employee is posted for other to comment upon.

10. A system as in claim 1 wherein the display is a webpage accessible to a member of company leadership to which recognition given in a communication transaction to an individual employee is posted.

11. A system as in claim 1 wherein the display is a webpage accessible to an individual employee to which recognition given in a communication transaction to the individual employee is posted.

12. A system as in claim 11 wherein the webpage accessible to an individual employee further comprises an account summary, the account summary displaying strengths recognized, any value attributable to the strengths recognized, and any accumulation of value that the individual employee can redeem for an award.

13. A system for extracting strengths attributable to one or more persons from a database containing communication transactions within a company communication system and providing metrics that reflect skills attributable to the persons comprising:
a skills finder feature having a skills finding search engine and a dictionary comprising words associated with strengths;
a controller for initiating the skills finder feature to identify communication transactions created or modified within the company communication system within a current predetermined period of time, the skills finder feature executes against a temporary table of the communications transactions for the current predetermined period of time;
a change data capture feature that determines the communication transactions that occurred since the controller last initiated the skills finder feature to conduct an extraction of strengths, the change data capture feature creates the temporary table; and
the skills finding search engine searches the temporary table for words within the dictionary and extracts each strength recognized in a communication transaction for each of the persons, the skills finder feature associates each of the extracted strengths with one or more skills categories, aggregates the skills categories, and compiles an aggregated table that contains information depicting the skills categories for each of the persons accumulated from previous predetermined time periods and the current predetermined period of time.

14. A system as in claim 13 wherein the communication system is an email system.

15. A system as in claim 1 further comprising a middle-tier application programming interface that processes any request for the information from the aggregated table.

16. A system as in claim 1 wherein the dictionary further comprises root words associated with strengths and with associated skills.

17. A system as in claim 1 wherein at least one of the strengths recognized has a value that one of the persons can redeem for an award.

18. A method for extracting strengths attributable to one or more persons from a database containing communication transactions within a company communication system and providing metrics that reflect skills attributable to the persons comprising the steps:
initiating a skills finder feature to identify communication transactions created or modified within the company communication system within a current predetermined period of time;
creating a temporary table of the communications transactions for the current predetermined period of time; and
executing against the temporary table of the communications transactions for the current predetermined period of time, such executing against the temporary table comprising the steps of:
searching the temporary table for words within a dictionary predetermined to have association with strengths to be recognized;
extracting from the temporary table each word within the dictionary that is associated with strengths to be recognized;
identifying each of the strengths to be recognized;
associating each of the strengths identified with one or more skills categories;
aggregating each occurrence of recognition within the skills categories, and
compiling an aggregated table that contains information depicting the skills categories for each of the persons accumulated from previous predetermined time periods and the current predetermined period of time.

19. A method as in claim 18 wherein the dictionary further comprises root words associated with strengths and with associated skills.

20. A method as in claim 18 further comprising the step of displaying at least a portion of the information depicted in the aggregated table.
